(19) United States
(12) Patent Application Publication
(10) Pub. No.: US 2023/0170457 A1
(43) Pub. Date: Jun. 1, 2023

(54) RECHARGEABLE LITHIUM BATTERY

(71) Applicant: SAMSUNG SDI CO., LTD., Yongin-si (KR)

(72) Inventors: Inho JUNG, Yongin-si (KR); Kyungsu RYU, Yongin-si (KR); Jinseong YOO, Yongin-si (KR)

(21) Appl. No.: 17/992,338

(22) Filed: Nov. 22, 2022

(30) Foreign Application Priority Data
Nov. 24, 2021 (KR) 10-2021-0163697

(51) Int. Cl. H01M 4/02; H01M 4/36; H01M 4/38; H01M 4/587; H01M 4/525; H01M 10/0525

(52) U.S. Cl. CPC H01M 4/02; H01M 4/364; H01M 4/386; H01M 4/525; H01M 4/587; H01M 10/0525; H01M 2004/021

(57) ABSTRACT

A rechargeable lithium battery includes a positive electrode including a positive active material; a negative electrode including a negative active material; a separator positioned between the positive electrode and the negative electrode; and a non-aqueous electrolyte, wherein the negative electrode has an active mass density of about 1.6 g/cc or more, and the rechargeable lithium battery has an inner pressure of about 0.95 kgf/cm² to about 1.65 kgf/cm².

### CROSS-REFERENCE TO RELATED APPLICATION

This application claims priority to and the benefit of Korean Patent Application No. 10-2021-0163697 filed in the Korean Intellectual Property Office on Nov. 24, 2021, the entire contents of which are incorporated herein by reference.

### BACKGROUND

### 1. Field

The present disclosure relates to a rechargeable lithium battery.

### 2. Description of the Related Art

With the development of mobile devices, demand has increased for rechargeable lithium batteries as energy sources. As an example, a cylindrical secondary battery may include an electrode assembly that provides charging and discharging, a case that houses the electrode assembly, and a cap assembly that electrically connects to the electrode assembly and seals an opening of the case.

A rechargeable lithium battery may be fabricated by preparing an electrode assembly including a positive electrode, a separator, and a negative electrode, inserting the electrode assembly into a battery case, and injecting an electrolyte therein.

### SUMMARY

The embodiments may be realized by providing a rechargeable lithium battery including a positive electrode including a positive active material; a negative electrode including a negative active material; a separator positioned between the positive electrode and the negative electrode; and a non-aqueous electrolyte, wherein the negative electrode has an active mass density of about 1.6 g/cc or more, and the rechargeable lithium battery has an inner pressure of about 0.95 kgf/cm² to about 1.65 kgf/cm².

The inner pressure of the battery may be a value obtained after formation charging and discharging the rechargeable lithium battery.

The negative electrode may have an active mass density of about 1.6 g/cc to about 1.75 g/cc.

The positive electrode may have an active mass density of about 3.4 g/cc to about 3.9 g/cc.

The inner pressure of the battery may be about 0.95 kgf/cm² to about 1.6 kgf/cm².

The positive active material may be represented by Chemical Formula 1 or Chemical Formula 2,

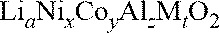

in Chemical Formula 1, 0.9≤a≤1.1, 0.75≤x≤0.92, 0.05≤y≤0.2, 0.03≤z≤0.2, x+y+z+t= 1, and M may be Mg, Ba, B, La, Y, Ti, Zr, Mn, Si, V, P, Mo, W, F, or a combination thereof,

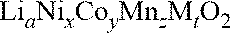

in Chemical Formula 2, 0.9≤a≤1.1, 0.4≤x≤0.94, 0.03≤y≤0.3, 0.03≤z≤0.4, 0≤t≤0.1, and x+y+z+t= 1, and M may be Mg, Ba, B, La, Y, Ti, Zr, Mn, Si, V, P, Mo, W, F, or a combination thereof.

The negative active material may be a carbon material or a mixture of a carbon material and a silicon material.

### BRIEF DESCRIPTION OF THE DRAWING

Features will be apparent to those of skill in the art by describing in detail exemplary embodiments with reference to the attached drawing in which:

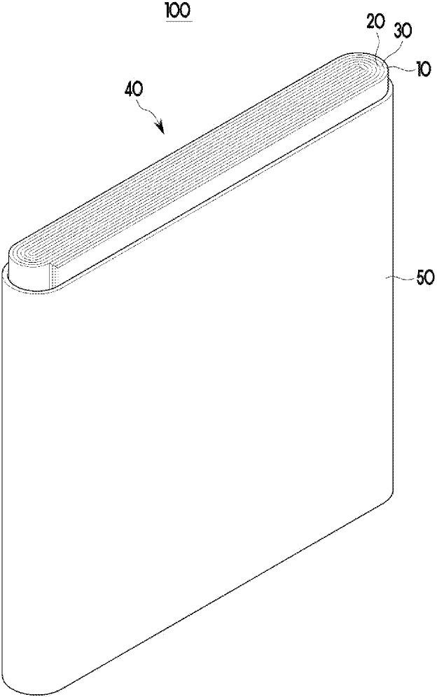

the FIG. 1 is a partial exploded perspective view of a rechargeable lithium battery according to one embodiment.

### DETAILED DESCRIPTION

Example embodiments will now be described more fully hereinafter with reference to the accompanying drawing. The example embodiment may be embodied in different forms and should not be construed as limited to the embodiments set forth herein. Rather, these embodiments are provided so that this disclosure will be thorough and complete, and will fully convey exemplary implementations to those skilled in the art.

A rechargeable lithium battery according to one embodiment may include a positive electrode including a positive active material, a negative electrode including a negative active material, and a separator positioned between the negative electrode the positive electrode, and a non-aqueous electrolyte, wherein the negative electrode may have an active mass density of about 1.6 g/cc or more, and the rechargeable lithium battery may have an inner pressure of about 0.95 kgf/cm² to about 1.65 kgf/cm².

The rechargeable lithium battery according to one embodiment may have an inner pressure of about 0.95 kgf/cm² to about 1.65 kgf/cm² which may be maintained as a lower value after formation charging and discharging, and may be very much lower than an, e.g., conventional value of 1.8 kgf/cm². As such, the inner pressure of the battery after formation charging and discharging may be maintained at a lower state such that excellent battery characteristics, particularly, excellent capacity retention, may be exhibited.

Generally, when charging and discharging of a rechargeable lithium battery are repeated, the positive electrode and the negative electrode could repeatedly expanded and contracted. For example, a volume change of about 20 volume% in the negative electrode and a volume change of about 3 volume% to about 7 volume% in the positive electrode could occur, such that the inner pressure of the battery may be changed. Such changes in pressure may cause a widening or narrowing of a gap of the negative electrode and the positive electrode, and thus, the inner pressure of the battery may become too high or too low, such that lithium ion movement may not be sufficient. Deformation of the electrode and side reactions may occur, thereby deteriorating cycle-life characteristics.

The rechargeable lithium battery according to one embodiment may maintain an inner pressure of about 0.95 kgf/cm² to about 1.65 kgf/cm² after formation charging and discharging, and thus, the movement of lithium ions may occur sufficiently. If the inner pressure of the battery were to be lower or higher than this range, the cycle-life characteristics could be deteriorated.

The term “inner pressure” refers to the pressure after formation charging and discharging, and does not refer to an inner pressure of the battery prior to formation charging and discharging, for example, a pressure that exists right after assembling a battery (after injecting an electrolyte). In one embodiment, an inner pressure of the battery may be about 0.6 kgf/cm² to about 1.05 kgf/cm² prior to formation charging and discharging and after battery assembly.

As described above, the rechargeable lithium battery according to one embodiment may include the negative electrode with a high active mass density of about 1.6 g/cc or more, or about 1.6 g/cc to about 1.75 g/cc.

In the specification, the term “active mass” refers to an active material layer. The term “active mass density” refers to the density of the active material layer.

When the active mass density of the negative electrode is within the above-described range, the electrolyte may be suitably impregnated into the negative electrode, which may allow an inner pressure after formation charging and discharging to be suitably maintained. If the active mass density of the negative electrode were to be out of the above-described range, the inner pressure of the battery could be extremely increased or reduced after formation charging and discharging.

Generally, a rechargeable lithium battery may be fabricated by injecting an electrolyte into an electrode assembly including a positive electrode, a separator, and a negative electrode. It is desirable to sufficiently impregnate the electrolyte into voids between the active materials naturally included in the active mass, that is, the active material layer, in the injection of the electrolyte. Herein, a reduction of time for injecting the electrolyte solution may be realized by performing the electrolyte injection under a vacuum condition or a pressurization condition.

A rate of impregnating the electrolyte may depend on a size of the voids present inside of the active mass, that is, the active material layer. If the size of the void were to be small, capillary effects due to natural impregnation rather than external pressure could be more effective, but if the size of voids is a predetermined size or more, an effect of external pressure (pressurization) may be enlarged.

If the active mass of the negative electrode were to be increased to about 1.6 g/cc or more in order to obtain a high-capacity battery, the size of voids naturally presented in the negative active material layer may become smaller. Thus, even if the injection of the electrolyte were to be performed under a vacuum condition or a pressurization condition, a reduction in the rate of injecting may be insufficient.

Accordingly, natural impregnation, e.g., allowing an active mass to stand under atmospheric conditions, may render an improvement in a rate of impregnation of electrolyte in the active mass density of the negative electrode of about 1.6 g/cc or more. Such a capillary effect may be effectively obtained when the inner pressure of the battery is adjusted to about 0.95 kgf/cm² to about 1.65 kgf/cm² after formation charging and discharging. According to one embodiment, the inner pressure of the battery may be about 0.95 kgf/cm² to about 1.6 kgf/cm².

Such an inner pressure may be controlled by adjusting times for allowing the active mass to stand (buffer time) prior to sealing the battery case after assembling the battery. In one embodiment, the time for allowing the active mass to stand may be about 45 minutes to about 60 minutes. For example, sealing the battery case may be performed after the battery is assembled and after time has passed for about 45 minutes to about 60 minutes.

If the density of the active mass of the negative electrode were to be about 1.6 g/cc or more, and the inner pressure of the battery were to be less than about 0.95 kgf/cm², or more than about 1.6 kgf/cm², capacity retention could be deteriorated. In addition, if the density of the active mass of the negative electrode were to be less than 1.6 g/cc, even though the inner pressure is within a range of about 0.95 kgf/cm² to about 1.6 kgf/cm², capacity retention could be deteriorated.

The inner pressure may be obtained after formation charging and discharging the rechargeable lithium battery. The formation charge and discharge may be performed by charging and discharging at about 0.05 C to about 0.7 C once or up to three times. Herein, the formation charge and discharge may be performed under a constant current-constant voltage condition.

The inner pressure may be measured by suitable techniques.

In an embodiment, a density of an active mass of the positive electrode may be about 3.4 g/cc to about 3.9 g/cc. When he density of the active mass of the positive electrode is within the range a high capacity may be obtained. When the battery with the aforementioned densities of the active masses of the negative electrode and the positive electrode have an inner pressure of about 0.95 kgf/cm² to about 1.65 kgf/cm² after formation charge and discharge, the capacity retention may even more suitably obtained.

In such a rechargeable lithium battery, the negative electrode may include a current collector and a negative active material layer on at least one surface of the current collector. The negative active material layer may include a negative active material, a binder, and, optionally, a conductive material.

The negative active material may include a carbon material or a mixture of a carbon material and a silicon material.

In some implementations, the carbon material may include crystalline carbon. The crystalline carbon may include, e.g., artificial graphite, natural graphite, or a combination thereof. In some implementations, the Si negative active material may include, e.g., Si, a Si-C composite, SiOₓ (0 < x < 2), or a Si-Q alloy (wherein Q is an alkali metal, an alkaline-earth metal, a Group 13 element, a Group 14 element, a Group 15 element, a Group 16 element, a transition metal, a rare earth element, or a combination thereof, but not Si). In an implementation, the element Q may be an element selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. As used herein, the term “or” is not an exclusive term, e.g., “A or B” would include A, B, or A and B.

The Si—C composite may include silicon and carbon. The carbon may be amorphous carbon, or a combination of amorphous carbon and crystalline carbon. In an implementation, the Si—C composite may be a silicon-carbon composite having a core including crystalline carbon and silicon, and an amorphous carbon coating layer surrounding the core. In an implementation, the Si—C composite may be a silicon-carbon combination that includes agglomerated products in which crystalline carbon and silicon are agglomerated and an amorphous carbon is positioned on a surface of the agglomerated products.

The amorphous carbon may be, e.g., soft carbon, hard carbon, mesophase pitch carbide, sintered cokes, or a combination thereof. The crystalline carbon may be natural graphite, artificial graphite, or a combination thereof.

In an implementation, when the negative active material is a mixture of the carbon material and the silicon material, the amount of silicon included in the negative active material may be about 2 wt% to about 10 wt% based on a total weight, e.g., 100 wt%, of the negative active material. When the amount of silicon included in the negative active material is within the range, an electrolyte may be appropriately impregnated in the negative electrode, thereby allowing a suitable inner pressure to be maintained.

In a mixture of the carbon material and the silicon material, a mixing ratio of the carbon material and the silicon material may be appropriately adjusted as long as the amount of silicon is within the above range in 100 wt% of the negative active material.

In the negative active material layer, the amount of the negative active material may be about 95 wt% to about 99 wt% based on the total (100 wt%) weight of the negative active material layer. In the negative active material layer, the amount of the binder may be 1 wt% to 5 wt% based on the total weight of the negative active material layer. When the negative active material layer further includes a conductive material, the negative active material layer may include about 90 wt% to about 98 wt% of the negative active material, about 1 wt% to about 5 wt% of the binder, and about 1 wt% to about 5 wt% of the conductive material.

The binder may help improve the binding properties of negative active material particles with one another and with a current collector. The binder may be a non-aqueous binder, an aqueous binder, or a combination thereof.

The non-aqueous binder may be, e.g., an ethylene propylene copolymer, polyacrylonitrile, polystyrene, polyvinylchloride, carboxylated polyvinylchloride, polyvinylfluoride, polyurethane, polytetrafluoro ethylene, polyvinylidene fluoride, polyethylene, polypropylene, polyamide imide, polyimide, or a combination thereof.

The aqueous binder may be, e.g., a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polyepichlorohydrin, polyphosphazene, an ethylene propylene diene copolymer, polyvinylpyridine, chlorosulfonated polyethylene, latex, polyester resin, an acrylic resin, a phenolic resin, an epoxy resin, polyvinyl alcohol, or a combination thereof.

When the aqueous binder is used as a negative electrode binder, a cellulose compound may be further included to provide viscosity as a thickener. The cellulose compound may include carboxymethyl cellulose, hydroxypropyl methyl cellulose, methyl cellulose, or alkali metal salts thereof. The alkali metal may be Na, K, or Li. The cellulose compound may be included in an amount of about 0.1 parts by weight to about 3 parts by weight based on 100 parts by weight of the negative active material.

The conductive material may be included to provide electrode conductivity. A suitable electrically conductive material that does not cause a chemical change may be used as the conductive material. The conductive material may include, e.g., a carbon material such as natural graphite, artificial graphite, carbon black, acetylene black, ketjen black, a carbon fiber, or the like; a metal material such as a metal powder or a metal fiber including copper, nickel, aluminum, silver, or the like; a conductive polymer such as a polyphenylene derivative; or a mixture thereof.

The current collector may include a copper foil, a nickel foil, a stainless steel foil, a titanium foil, a nickel foam, a copper foam, a polymer substrate coated with a conductive metal, or a combination thereof.

A density of an active mass of the positive electrode may be about 3.4 g/cc to about 3.9 g/cc, or, according to an embodiment, about 3.5 g/cc to about 3.7 g/cc.

The positive active material may be represented by Chemical Formula 1 or Chemical Formula 2.

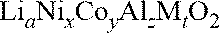

(wherein 0.9≤a≤1.1, 0.75≤x≤0.92, 0.05≤y≤0.2, 0.03≤z≤0.2, 0≤t≤0.1, x+y+z+t= 1, and M may be, e.g., Mg, Ba, B, La, Y, Ti, Zr, Mn, Si, V, P, Mo, W, F, or a combination thereof.)

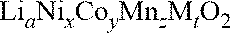

(wherein 0.9<a<1.1, 0.4≤x≤0.94, 0.03≤y≤0.3, 0.03≤z≤0.4, 0≤t≤0.1, x+ y+z+t= 1, and M may be, e.g., Mg, Ba, B, La, Y, Ti, Zr, Mn, Si, V, P, Mo, W, F, or a combination thereof.)

As such, the positive active material may be a nickel positive active material having an amount of nickel of about 40 mol% or more, or about 75 mol% or more. When the nickel positive active material is used as the positive active material, the inner pressure after formation charge and discharge may be suitably maintained.

The positive electrode according to one embodiment may include a current collector and a positive active material layer formed on the current collector.

In the positive electrode, an amount of the positive active material may be about 90 wt% to about 98 wt% based on the total weight of the positive active material layer.

In an implementation, the positive active material layer may further include a binder and a conductive material. Herein, the binder and the conductive material may be included in an amount of about 1 wt% to about 5 wt%, respectively, based on the total weight of the positive active material layer.

The binder may improve the binding properties of positive active material particles with one another and with a current collector. Examples thereof may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene butadiene rubber, an acrylated styrene butadiene rubber, an epoxy resin, nylon, and the like.

The conductive material may be included to provide electrode conductivity. A suitable electrically conductive material that does not cause a chemical change may be used as a conductive. Examples of the conductive material may include: a carbon material such as natural graphite, artificial graphite, carbon black, acetylene black, ketjen black, a carbon fiber, or the like; a metal material of a metal powder or a metal fiber including copper, nickel, aluminum, silver, or the like; a conductive polymer such as a polyphenylene derivative; or a mixture thereof.

In an implementation, the current collector may be made of, e.g., Al.

The positive electrode and the negative electrode may be prepared by mixing the active material, the binder and optionally, the conductive material in a solvent to prepare an active material composition and coating the active material composition onto the current collector. In an implementation, the solvent may be, e.g., N-methylpyrrolidone. When the aqueous binder is used in the negative active material layer, water may be used as a solvent in the preparation of the negative active material composition.

The separator may include a porous substrate and a coating layer including a ceramic positioned on one side of the porous substrate.

The porous substrate may include polyethylene, polypropylene, aramid, polyimide, or a combination thereof.

The ceramic may include Al₂O₃, MgO, TiO₂, Al(OH)₃, Mg(OH)₂, Ti(OH)₄, or a combination thereof.

A total thickness of the separator may be determined according to the target capacity of the battery. In an implementation, the thickness of separator may be about 10 µm to about 30 µm. In an implementation, the thickness of the ceramic-included coating layer may be, e.g., about 0.1 µm to about 5 µm, as a reference of one side.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methyl propionate, ethyl propionate, propyl proionate, decanolide, mevalonolactone, caprolactone, or the like. The ether solvent may include dibutyl ether, tetraglyme, diglyme, dimethoxyethane, 2-methyltetrahydrofuran, tetrahydrofuran, and the like. The ketone solvent may include cyclohexanone, or the like. The alcohol solvent may include ethyl alcohol, isopropyl alcohol, or the like, and examples of the aprotic solvent may include nitriles such as R-CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and the like.

The organic solvent may be used alone or in a mixture. When the organic solvent is used in a mixture, the mixture ratio may be controlled in accordance with a desirable battery performance as may be well understood to one of ordinary skill in the related art.

The carbonate solvent may include a mixture of a cyclic carbonate and a linear carbonate. The cyclic carbonate and linear carbonate may be mixed together in a volume ratio of about 1:1 to about 1:9. When the mixture is used as an electrolyte, the solvent may have enhanced performance.

When the non-aqueous organic solvents are mixed and used, a mixed solvent of cyclic carbonate and linear carbonate, a mixed solvent of cyclic carbonate and a propionate solvent, or a mixed solvent of cyclic carbonate, linear carbonate and a propionate solvent may be used. The propionate solvent may include methyl propionate, ethyl propionate, propyl propionate, or a combination thereof.

Herein, when a mixture of cyclic carbonate and linear carbonate, or a mixture of cyclic carbonate and propionate solvent is used, it may be desirable to use the mixture with a volume ratio of about 1:1 to about 1:9 considering the performances. In some implementations, a cyclic carbonate, linear carbonate, and propionate solvent may be mixed and used at a volume ratio of 1:1:1 to 3:3:4. The ratio of the mixed solvents may be appropriately adjusted according to the desired properties.

The organic solvent may further include an aromatic hydrocarbon solvent as well as the carbonate solvent. In an implementation, the carbonate solvent and aromatic hydrocarbon solvent may be mixed together in a volume ratio of about 1:1 to about 30:1.

The aromatic hydrocarbon organic solvent may be an aromatic hydrocarbon-based compound represented by Chemical Formula 3.

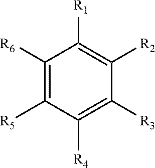

In Chemical Formula 3, R₁ to R₆ are the same or different and may include, e.g., hydrogen, a halogen, a C1 to C10 alkyl group, a haloalkyl group, or a combination thereof.

Examples of the aromatic hydrocarbon organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinyl ethylene carbonate, vinylene carbonate, or an ethylene carbonate compound represented by Chemical Formula 4, as an additive for improving cycle life.

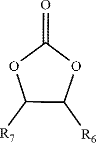

In Chemical Formula 4, R₇ and R₈ are the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate compound may include difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. When the additive is used for improving the cycle life, the amount of the additive may be suitably controlled within an appropriate range.

In an implementation, the electrolyte may further include propane sultone, succinonitrile, lithium difluorophosphate (LiPO₂F₂), 2-fluoro biphenyl (2-FBP), or a compound represented by Chemical Formula 5 as an additive. The amount thereof may be appropriately controlled.

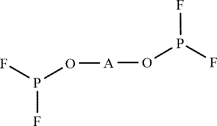

(wherein A is a substituted or unsubstituted aliphatic chain or (—C₂H₄—O—C₂H₄—)n, wherein n is an integer of about 1 to about 10.)

The lithium salt dissolved in an organic solvent may supply the battery with lithium ions, basically operates the rechargeable lithium battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), where x and y are a natural numbers, for example, an LiB(C₂O₄)₂ (lithium bis(oxalato) borate: LiBOB) and lithium difluoro(oxalato)borate (LiDFOB), as a supporting salt. A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

The FIGURE is a partial exploded perspective view of a rechargeable lithium battery according to an embodiment. In an implementation, as illustrated in the FIGURE, the lithium secondary battery according to an embodiment may be, e.g., a prismatic battery. In an implementation rechargeable lithium battery may include variously-shaped batteries such as a cylindrical battery, a pouch battery, or the like.

Referring to the FIGURE, the rechargeable lithium battery 100 according to an embodiment may include an electrode assembly 40 manufactured by winding a separator 30 between a positive electrode 10 and a negative electrode 20. The electrode assembly 40 may be housed in a case 50. An electrolyte may be impregnated in the positive electrode 10, the negative electrode 20 and the separator 30.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### Example 1

96 wt% of a LiNi_{0.88}Co_{0.11}Al_{0.01}O₂ positive active material, 2 wt% of acetylene black, and 2 wt% of polyvinylidene fluoride were mixed in an N-methyl pyrrolidone solvent to prepare a positive active material slurry. The positive active material slurry was coated and dried by followed by pressurizing to prepare a positive electrode with a density of an active mass of 3.63 g/cc.

97 wt% of a mixture of a carbon material and a silicon-carbon composite (the mixing ratio of the carbon material and the silicon-carbon composite was a 93.2:6.8 weight ratio, and the carbon material was a mixture of artificial graphite and natural graphite at an 8:2 weight ratio) as a negative active material, 2 wt% of styrene butadiene rubber, and 1 wt% of carboxymethyl cellulose were mixed in an water solvent to prepare a negative active material slurry.

As the silicon-carbon composite, a core including artificial graphite and silicon nanoparticles and a soft carbon coating layer formed on the surface of the core was used.

The negative active material slurry was coated on a Cu current collector and dried, followed by pressurizing to prepare a negative electrode with a density of an active mass of 1.66 g/cc.

As a separator, a polyethylene substrate with Al₂O₃ coated on one side of the substrate was used.

The positive electrode, the separator, and the negative electrode were sequentially stacked to prepare an electrode assembly, and the electrode assembly was inserted into a battery case. Thereafter, an electrolyte was injected into the electrode assembly inserted into the battery case and allowed to stand for 50 minutes (buffer time). The battery case was sealed to fabricate a rechargeable lithium cell.

As the electrolyte, a 1.5 M LiPF₆ solution in a mixed solvent of ethylene carbonate, ethyl methyl carbonate, and dimethyl carbonate (20:10:70 volume ratio) was used as an electrolyte precursor. 10 wt% of fluoroethylene carbonate was added to 100 wt% of the electrolyte precursor to prepare the electrolyte.

### Example 2

A rechargeable lithium battery cell was fabricated by the same procedure as in Example 1, except that a density of an active mass of the negative electrode was changed to 1.6 g/cc and a buffer time was changed to 45 minutes.

### Example 3

A rechargeable lithium battery cell was fabricated by the same procedure as in Example 1, except that only the silicon-carbon composite was used as the negative active material, thereby changing the density of the active mass of the negative electrode to 1.75 g/cc. The buffer time was changed to 60 minutes.

### Example 4

97 wt% of a mixture of artificial graphite and natural graphite (8:2 weight ratio) as a carbon negative active material, 2 wt% of styrene butadiene rubber, and 1.0 wt% of carboxymethyl cellulose were mixed in a water solvent to prepare a negative active material slurry.

The negative active material slurry was coated on a Cu current collector and dried followed by pressurizing to prepare a negative electrode with a density of an active mass of 1.75 g/cc .

As a separator, a polyethylene substrate separator with a thickness of 14 µm was used.

A 1.5 M LiPF₆ solution in a mixed solvent of ethylene carbonate, ethyl methyl carbonate, and dimethyl carbonate (20:10:70 volume ratio) was used as an electrolyte precursor, and 3 wt% of fluoroethylene carbonate was added to 100 wt% of the electrolyte precursor to prepare the electrolyte.

The positive electrode, the separator, and the negative electrode were sequentially stacked to prepare an electrode assembly, and the electrode assembly was inserted into a battery case. Thereafter, the electrolyte was injected into the electrode assembly inserted into the battery case, allowed to stand for 60 minutes (buffer time), and the battery case was sealed to fabricate a rechargeable lithium cell.

### Comparative Example 1

A rechargeable lithium battery was fabricated by the same procedure as in Example 1, except that the electrolyte was injected into the electrode assembly under a pressurization condition of 4.6 kgf/cm². Allowing the battery case to stand before sealing was not performed. That is, the electrolyte was injected and the battery case was sealed immediately.

### Comparative Example 2

A rechargeable lithium battery cell was fabricated by the same procedure as in Example 1, except that only the silicon-carbon composite was used as the negative active material, thereby changing the density of the active mass of the negative electrode to 1.5 g/cc. The electrolyte was injected into the electrode assembly under a pressurization condition of 4.6 kgf/cm². Allowing the battery case to stand before sealing not performed. That is, the electrolyte was injected and the battery case was sealed immediately.

### Comparative Example 3

A rechargeable lithium battery cell was fabricated by the same procedure as in Example 1, except that a negative electrode with a density of an active mass of 1.6 g/cc was prepared, the electrolyte was injected into the electrode assembly under a reduced pressure condition until the pressure is of 0.1 kgf/cm². Allowing to the battery case to stand before sealing was not performed. That is, the electrolyte was injected and the battery case was sealed immediately.

### Comparative Example 4

A rechargeable lithium battery cell was fabricated by the same procedure as in Example 1, except that only the carbon material was used as the negative active material, thereby changing a density of an active mass of the negative electrode to 1.5 g/cc. The electrolyte was injected into the electrode assembly under a pressurization condition of 4.6 kgf/cm². Allowing the battery case to stand was not performed. That is, the electrolyte was injected and the battery case was sealed immediately.

### Comparative Example 5

A rechargeable lithium battery cell was fabricated by the same procedure as in Example 4, except that a negative electrode with a density of an active mass of 1.5 g/cc was prepared, the electrolyte was injected into the electrode assembly under a pressurization condition of 4.6 kgf/cm². Allowing the battery case to stand was not performed.

That is, the electrolyte was injected and the battery case was sealed immediately.

Experimental Example 1) Measurement of inner pressure after formation

The rechargeable lithium cells according to Examples 1 to 4 and Comparative Examples 1 to 5 were formation charged and discharged at 0.1 C to 2.75 V to 4.2 V under a constant-current and constant-voltage for three cycles, and then the cells were punched using a jig mounted with a pressure sensor to measure an inner pressure of the cell. The results are shown in Table 1.

Experimental Example 2) Measurement of capacity retention

The rechargeable lithium cells according to Examples 1 to 4 and Comparative Examples 1 to 5 were formation charged and discharged according to Experimental Example 1, were charged and discharged at 0.5 C for 200 cycles and a ratio of discharge capacity at the 200^{th} cycle to discharge capacity at the 1st cycle was determined. The results are shown in Table 1.

TABLE 1

| | Type of negative active material | Density of active mass of negative electrode (g/cc) | Whether pressurized during the pouring process | Inner pressure after formation charge and discharge (kgf/cm²) | Capacity retention (%) (after 200 cycles) |
|---|---|---|---|---|---|
| Comparative Example 1 | carbon material and silicon material | 1.66 | ◯ | 1.846 | 85.9 |
| Comparative Example 2 | carbon material | 1.5 | ◯ | 2.177 | 84.5 |
| Comparative Example 3 | carbon material and silicon material | 1.6 | X (under reduced pressure) | 0.679 | 83.9 |
| Comparative Example 4 | carbon material | 1.5 | ◯ | 1.65 | 87 |
| Comparative Example 5 | carbon material | 1.5 | ◯ | 2.147 | 85.6 |
| Example 1 | carbon material and silicon material | 1.66 | X | 1.397 | 91.8 |
| Example 2 | carbon material and silicon material | 1.6 | X | 0.987 | 90.2 |
| Example 3 | carbon material | 1.72 | X | 1.597 | 93.2 |
| Example 4 | carbon material | 1.75 | X | 1.597 | 93.2 |

As shown in Table 1, the rechargeable cells according to Examples 1 to 4, having the density of the active mass of the negative electrode of 1.6 g/cc or more and satisfying the inner pressure of 0.95 kgf/cm² to 1.65 kgf/cm² after formation charge and discharge, exhibited excellent capacity retention.

On the other hand, the rechargeable cells according to Comparative Examples 2 and 5 in which the density of the active mass of the negative electrode and the inner pressure after formation charge and discharge were not satisfied, exhibited poor capacity retention.

In addition, although the density of the active mass of the negative electrode was 1.66 g/cc, the inner pressure after formation charge and discharge was 1.846 kgf/cm² which was too high (Comparative Example 1), or 0.679 kgf/cm² which was too low (Comparative Example 3), which caused these rechargeable cells to exhibit deteriorated capacity retention. Particularly, the rechargeable cell of Comparative Example 3 having too low an inner pressure of 0.679 kgf/cm² exhibited poorer capacity retention than Comparative Example 2 of which the active mass density of the negative electrode and the inner pressure were both not satisfied.

When the active mass density was 1.5 g/cc which was low after formation charge and discharge, the suitable capacity retention could not be obtained as with Comparative Example 4, even if the inner pressure was 1.65 kgf/cm².

By way of summation and review, a formation charging may be performed in order to activate the rechargeable lithium battery, and during the formation charging, gas may be generated, thereby increasing an inner pressure. A method of performing degassing that removes gas could be performed in order to suppress increases in inner pressure of the battery. If gas is insufficiently removed, the inner pressure of the rechargeable battery may still be increased.

It could be difficult to insert a device for degassing into a cylindrical rechargeable lithium battery, and thus, a degassing process may not be performed in the cylindrical rechargeable lithium battery. The inner pressure of the cylindrical rechargeable lithium battery could be mostly increased due to the generated gas.

One or more embodiments may provide a rechargeable lithium battery exhibiting improved cycle-life characteristics by controlling and setting in a predetermined range.

The rechargeable lithium battery according to one embodiment may exhibit excellent cycle-life characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable lithium battery, comprising:
a positive electrode including a positive active material;
a negative electrode including a negative active material;
a separator positioned between the positive electrode and the negative electrode; and
a non-aqueous electrolyte,
wherein:
the negative electrode has an active mass density of about 1.6 g/cc or more, and
the rechargeable lithium battery has an inner pressure of about 0.95 kgf/cm² to about 1.65 kgf/cm².

2. The rechargeable lithium battery as claimed in claim 1, wherein the inner pressure of the battery is a value obtained after formation charging and discharging the rechargeable lithium battery.

3. The rechargeable lithium battery as claimed in claim 1, wherein the negative electrode has an active mass density of about 1.6 g/cc to about 1.75 g/cc.

4. The rechargeable lithium battery as claimed in claim 1, wherein the positive electrode has an active mass density of about 3.4 g/cc to about 3.9 g/cc.

5. The rechargeable lithium battery as claimed in claim 1, wherein the inner pressure of the battery is about 0.95 kgf/cm² to about 1.6 kgf/cm².

6. The rechargeable lithium battery as claimed in claim 1, wherein:
the positive active material is represented by Chemical Formula 1 or Chemical Formula 2, 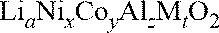
in Chemical Formula 1,
0.9<a<1.1, 0.75<x<0.92, 0.05<y<0.2, 0.03<z<0.2, x+y+z+t= 1, and
M is Mg, Ba, B, La, Y, Ti, Zr, Mn, Si, V, P, Mo, W, F, or a combination thereof, 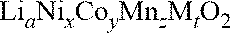
in Chemical Formula 2,
0.9≤a≤1.1, 0.4≤x≤0.94, 0.03≤y≤0.3, 0.03≤z≤0.4, 0≤t≤0.1, and x+y+z+t= 1, and
M is Mg, Ba, B, La, Y, Ti, Zr, Mn, Si, V, P, Mo, W, F, or a combination thereof.

7. The rechargeable lithium battery as claimed in claim 1, wherein the negative active material is a carbon material or a mixture of a carbon material and a silicon material.
